(19) United States
(12) Patent Application Publication
(10) Pub. No.: US 2016/0181685 A1
(43) Pub. Date: Jun. 23, 2016

(54) MONOLITHIC ANTENNA SOURCE FOR SPACE APPLICATION

(71) Applicant: THALES, COURBEVOIE (FR)

(72) Inventors: Florent LEBRUN, MAUZAC (FR); Patrick MARTINEAU, BLAGNAC (FR); Valérie ERBLAND, LABATIDETTE (FR); Karine CAIRE, TOULOUSE (FR)

(21) Appl. No.: 14/971,949

(22) Filed: Dec. 16, 2015

(30) Foreign Application Priority Data
Dec. 17, 2014 (FR) 1402878

(51) Int. Cl. H01Q 1/02; B23K 26/342; C25D 1/00; H01Q 1/36; H01Q 1/28

(52) U.S. Cl. CPC H01Q 1/02; H01Q 1/36; H01Q 1/288; C25D 1/00; B23K 26/342

(57) ABSTRACT

A monolithic antenna source for space application comprises: a set of RF components conveying electromagnetic waves and dissipating thermal energy, and an RF radiating element having a circular or pyramidal radiating surface, the source further comprising thermal transfer means extending from the set of RF components to the RF radiating element and over at least a portion of the RF radiating element substantially along a longitudinal axis of the source, the RF radiating element being adapted to evacuate energy by thermal radiation.

### CROSS-REFERENCE TO RELATED APPLICATION

This application claims priority to foreign French patent application No. FR 1402878, filed on Dec. 17, 2014, the disclosure of which is incorporated by reference in its entirety.

### FIELD OF THE INVENTION

The field of the invention concerns transmit/receive antennas configured for space applications and notably antennas on board satellites. The invention more particularly concerns the antenna sources.

### BACKGROUND

FIG. 1 represents a theoretical diagram of an antenna source 1 comprising a set of RF components 2 transmitting and processing waves in transmit or receive mode, the matching element 3, more commonly known as the “horn”, and the set of RF components 2 having a common section Sec. The section Sec common to the set of RF components 2 and the matching element 3 usually has a small area compared to the area of the output face Fs of the wave generated by the set of RF components 2.

The matching element 3 is generally of conical shape enabling progressive matching of the electromagnetic waves between the coupling point and a receiver.

At the present time, there exists a growing demand to increase the quantity of onboard equipment. Also, the RF components must process more data, which requires a greater quantity of electrical power and leads to an increase in the thermal energy dissipated by the set of RF components 2.

The increase in the temperature of the source 1 and more particularly of the set of RF components 2 leads to certain disadvantages:
On the one hand, this increase in temperature generates a reduction of the performance of the set of RF components 2. The performance of some RF components is degraded if the surrounding temperature is above a threshold value.
On the other hand, this increase in temperature generates thermo-elastic deformations of the materials used to produce the set of RF components 2 causing thermo-elastic dimension and deformation problems. Indeed, the section Sec common to the set of RF components 2 and the radiating surface 3 being small, the transfer of thermal energy between the set of RF components 2 and the matching element 3 is not efficient. The thermal energy generated at the level of the set of RF components 2 accumulates at level of the set of RF components 2, which generates a temperature gradient between the set of RF components 2 and the matching element 3 that can exceed 100° C. The source 1 then suffers non-homogeneous thermo-elastic deformations.

At present, the means employed to evacuate the thermal energy from the set of RF components 2 are based on thermal exchange systems:
The exterior surface of the set of RF components 2 is covered with white paint. The white coating improves the emission properties of the set of RF components 2, improving the thermal exchange capacities of the set of RF components 2 by radiation.
The set of RF components 2 is coupled to a heatsink covered with white paint. The use of a heatsink increases the area of thermal exchange to space which makes it possible to evacuate thermal energy from the set of RF components 2 to the heatsink by conduction and then to space by radiation.
The set of RF components 2 is coupled to a heatsink covered with optical solar reflector (OSR) elements, the OSR elements consisting of silver-plated silica films. These OSR elements produce a relatively high emissivity thus offering good thermal dissipation capacities by radiation. Moreover, the OSR elements have a low absorptivity, notably limiting the entry of solar radiation.

The known means proposed above are relatively ineffective and necessitate large thermal exchange areas that are not particularly compatible with the mass and overall size constraints associated with space applications.

### SUMMARY OF THE INVENTION

Also, an object of the invention is to propose an antenna source enabling dissipation of the thermal energy generated by the set of RF components that is efficient and compatible with the constraints of space applications.

In accordance with one aspect of the invention, there is proposed a monolithic antenna source for space application comprising:

a set of RF components conveying electromagnetic waves and dissipating thermal energy, and

an electromagnetic wave radiating element having a circular or pyramidal radiating surface,

the source further comprising thermal transfer means extending from the set of RF components to the RF wave radiating element and over at least a portion of the RF radiating element (4) substantially along a longitudinal axis (AL) of the source, the latter being adapted to evacuate thermal energy by thermal radiation.

The transfer of the thermal energy generated by the set of RF components to the radiating element makes it possible to increase effectively the thermal rejection capacities of an antenna source to the vacuum of space.

By circular surface is meant a surface generated by any curve that turns around a fixed straight line segment so that each of its points traces out a circle in a plane perpendicular to the axis.

By pyramidal surface is meant a surface comprising a polygonal base and triangular lateral faces, the lateral faces having a common apex.

The radiating element is preferably of cone shape simultaneously authorizing progressive matching of the electromagnetic waves and thermal exchange with space.

The thermal transfer means advantageously extend over at least a portion of the set of RF components so that the thermal transfer means recover or store the thermal energy dissipated by the set of RF components.

The thermal transfer means, the radiating element and the set of RF components are advantageously monolithic so as to limit the thermal constraints linked to the thermal coefficient differences. Alternatively, the thermal transfer means comprise a material different from that of the radiating element and the set of RF components.

The thermal transfer means advantageously extend over the radiating element so that the transfer of thermal energy from the set of RF components to the radiating element is homogeneous over all of the surface of the radiating element.

The thermal transfer means advantageously comprise a heat pipe. Alternatively, the thermal transfer means comprise a two-phase fluid loop.

The radiating element advantageously includes protuberances so as to increase the area of thermal exchange with space.

In accordance with another aspect of the invention, there is proposed a method of producing a monolithic space antenna source comprising a set of RF components conveying electromagnetic waves and dissipating thermal energy and a radiating element radiating the electromagnetic waves generated by the set of RF components having a radiating surface of circular pyramidal shape. The source further comprises thermal transfer means extending from the set of RF components to the RF radiating element and on the surface of the radiating element over at least a portion of the RF radiating element substantially along a longitudinal axis of source, the radiating element being adapted to dissipate thermal energy is manufactured by electroforming or alternatively by an additive fabrication method.

### BRIEF DESCRIPTION OF THE DRAWINGS

The invention will be better understood and other advantages will become apparent on reading the following description given by way of nonlimiting example and thanks to the appended drawings, in which:

FIG. 1, already described, represents a theoretical diagram of a prior art antenna source,

FIGS. 2a and 2b represent a theoretical diagram of an antenna source in accordance with the invention, and

FIG. 3 represents thermal means in accordance with the invention, and

FIG. 4 represents a theoretical diagram of an additive fabrication method that can be used to produce the antenna source in accordance with the invention.

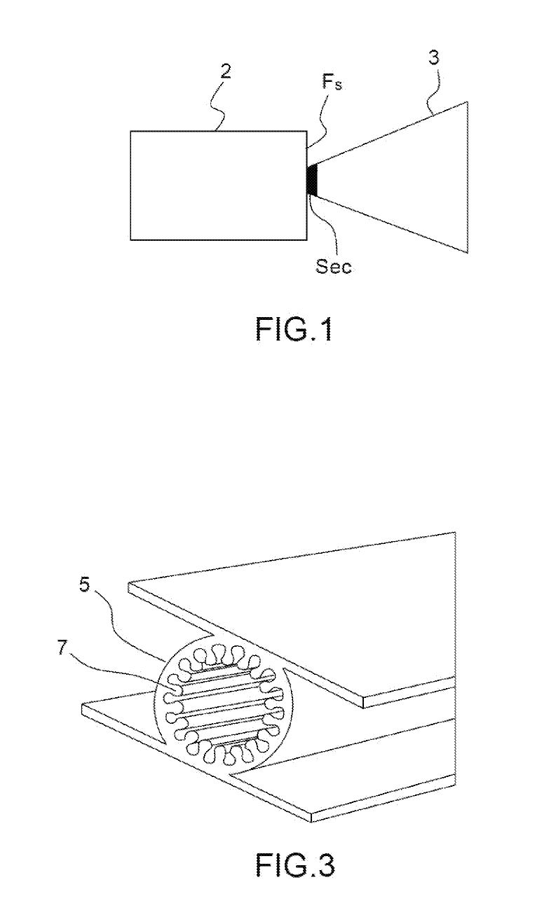

### DETAILED DESCRIPTION

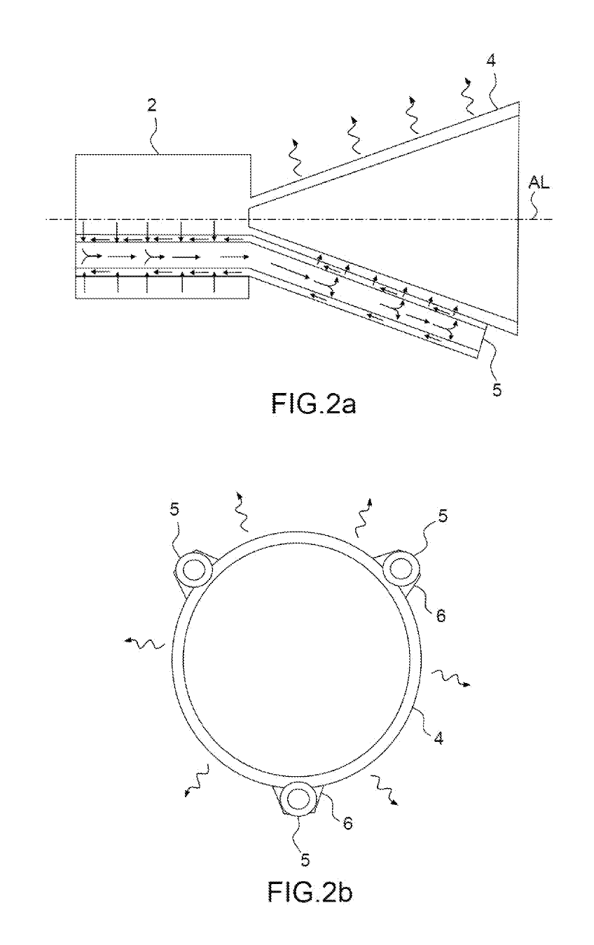

FIGS. 2a and 2b represent an antenna source 1 in accordance with one aspect of the invention.

The source comprises a set of RF components 2 and a radiating element 4, and the radiating element 4 enables matching of the electromagnetic waves between the coupling point and a receiver and thermal exchange to space. In other words, the radiating element 4 is a heatsink.

Here the antenna source 1 is monolithic. In other words, the set of RF components 2 and the radiating element 4 form a single block of the same material. This embodiment limits mechanical stresses linked to the thermal coefficient differences of the set of RF components 2 and the radiating element 4.

The material generally used for the fabrication of an antenna source 1 is aluminium although any other material may be used that is suitable for thermal exchange and radiation of electromagnetic waves.

The source further comprises means 5 for transferring thermal energy from the set of RF components 2 to the radiating element 4.

The thermal transfer means 5 extend from the set of RF components 2 to the RF radiating element 4 and over at least a portion of the RF radiating element 4 substantially along a longitudinal axis AL of the source, that axis corresponding to that along which the beam primarily develops.

The thermal transfer means 5 advantageously consist of a thermally conducting rod. The thermal transfer means 5 are preferably provided with heat-exchange fluid such as a heat pipe or a two-phase fluid loop. Heat pipes and two-phase loops have greater thermal rejection capacities than thermally conductive bars.

The thermal transfer means advantageously include splines 7, as shown in FIG. 3, so as to increase the area of thermal exchange between the thermal transfer means 5 and the set of RF components 2 on the one hand and the thermal transfer means 5 and the radiating element 4 on the other hand. Here, the thermal transfer means 5 consist of a heat pipe. The thermal energy stored at the level of the set of RF components 2 changes the physical state of the heat-exchange fluid circulating in the heat pipe. The heat-exchange fluid goes from a liquid state to a gas state. The fluid in vapour form moves toward the radiating element 4, the thermal energy is transmitted to the radiating element by conduction and evacuated by it to space by radiation. The heat-exchange fluid then reverts to the liquid state.

The thermal transfer means 5 advantageously extend over at least a portion of the set of RF components 2 so as to recover the thermal energy dissipated by the RF components 2.

The thermal transfer means 5 advantageously extend over at least a portion of the radiating surface. The thermal transfer means 5 preferably extend over the radiating element 4 so that the transfer of energy from the set of radiating RF components 2 to the radiating element 4 is homogeneous over all of the surface of the radiating element 4.

The thermal transfer means 5 are preferably on the surface of the set of RF components 2 and/or the surface of the radiating element 4. Alternatively, the thermal transfer means 5 are inside or within the thickness of the radiating element 5.

The radiating element 4 is advantageously of conical shape; the radiating element may alternatively be of pyramidal, frustoconical or any other shape suited to the progressive matching of the electromagnetic waves and offering a large thermal exchange area. The conical shape of the radiating element 4 is more efficient than a plane shape. Indeed, the conical shape offers a larger area of thermal exchange with space and reduces the sensitivity of the radiating element 4 to solar radiation. In other words, the radiating element 4 of conical shape does not receive solar radiation directly or perpendicularly only along a line, the rest of the surface of the radiating element receiving the solar radiation only indirectly.

The radiating element 4 advantageously includes external protuberances 6 of “iroquois” shape, as indicated in FIG. 2b, making it possible to increase the area of thermal exchange between the radiating element 4 and space. The thermal transfer means 5 are advantageously inside the protuberances 6.

The external surface of the radiating element 4 is advantageously covered with white paint or OSR elements.

The set of RF components 2, the radiating element 4 and the thermal transfer means 5 are advantageously monolithic. In other words, the whole of the source 1 forms a single block. Alternatively, the thermal transfer means 5 comprise a material different from that of the source 1.

The method employed to produce an antenna source 1 in accordance with the invention uses an additive method for the fabrication of the one-piece source 1. The most suitable additive method appears to be selective laser melting (SLM). This method enables the fabrication of complex parts with great precision and an acceptable surface quality.

The selective laser melting method is capable of producing metal parts using a high-power laser progressively and locally melting, in other words selectively melting, a metal powder in a controlled atmosphere.

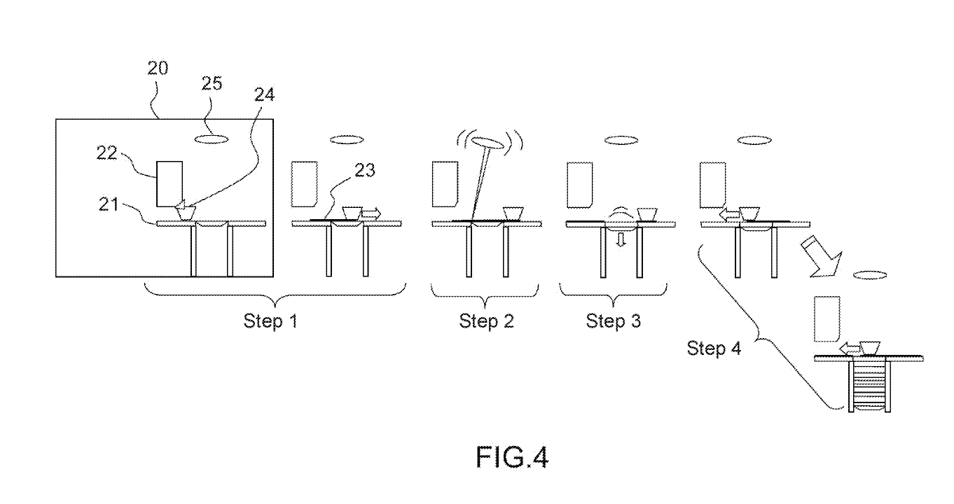

FIG. 4 represents a theoretical diagram of the selective laser melting method.

FIG. 4 represents a device adapted to implement the SLM method. The device 20 includes a platform 21 and a tank 22 dispensing metal powder 23; the metal powder may contain aluminium, titanium, copper or invar. After filling a carriage 24 with metal powder, the latter spreads a fine metal layer on a platform 21 in a first step. A high-power laser 25 then melts the metal powder 23 over a selected portion of the metal layer 23. After the melted metal powder 23 cools, a dense metal layer is formed. The process is then reproduced layer by layer until the required part is formed.

This method therefore makes it possible to form a monoblock source comprising a set of RF components, a radiating element and thermal transfer means recovering the thermal energy dissipated from the set of RF components 2 and transferring it to the radiating element 3.

Alternatively, the method employed for the production of the antenna source 1 uses an electroforming method. This technique consists in effecting a metal deposit on a support by chemical means. When the required thickness is achieved, the part is separated from its support.

Alternatively, the method employed for the production of the antenna source 1 uses an additive fabrication method.

1. A monolithic antenna source for space application comprising:
a set of RF components conveying electromagnetic waves and dissipating thermal energy, and
an RF radiating element having a circular or pyramidal radiating surface, the source further comprising thermal transfer means extending from the set of RF components to the RF radiating element and over at least a portion of the RF radiating element substantially along a longitudinal axis of the source, the RF radiating element being adapted to evacuate thermal energy by thermal radiation.

2. The monolithic antenna source according to claim 1 wherein the RF radiating element is of cone shape.

3. The monolithic antenna source according to claim 1 wherein the thermal transfer means extend over at least a portion of the set of RF components.

4. The monolithic antenna source according to claim 1 wherein the thermal transfer means, the RF radiating element and the set of RF components are monolithic.

5. The monolithic antenna source according claim 1 wherein the thermal transfer means comprise a material different from that of the RF radiating element and the set of RF components.

6. The monolithic antenna source according to claim 1 wherein the thermal transfer means extend over the RF radiating element so that the transfer of thermal energy from the RF components to the radiating element is homogeneous over all of the surface of the RF radiating element.

7. The monolithic antenna source according to claim 1 wherein the thermal transfer means consist of a heat pipe.

8. The monolithic antenna source according to claim 1 wherein the thermal transfer means consist of a two-phase fluid loop.

9. The monolithic antenna source according to claim 1 wherein the radiating element includes protuberances so as to increase the area of thermal exchange.

10. A method of producing a monolithic space antenna source comprising a set of RF components conveying electromagnetic waves and dissipating thermal energy and a radiating element having a radiating surface of circular pyramidal shape, the source further comprising thermal transfer means extending from the set of RF components to the RF radiating element and over at least a portion of the RF radiating element substantially along a longitudinal axis of the source; the RF radiating element being adapted to dissipate thermal energy is manufactured by electroforming.

11. The method of producing a monolithic space antenna source comprising a set of RF components conveying electromagnetic waves and dissipating thermal energy and an RF radiating element having a radiating surface of circular or pyramidal shape, the source further comprising thermal transfer means extending from the set of RF components to the RF radiating element and over at least a portion of the RF radiating element substantially along a longitudinal axis of the source; the RF radiating element being adapted to dissipate thermal energy is manufactured by an additive fabrication method.
